(19) United States
(12) Patent Application Publication
(10) Pub. No.: US 2005/0003877 A1
(43) Pub. Date: Jan. 6, 2005

(54) Systems and methods for playmaker control

(75) Inventor: Ian Cummings, Winter Park, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA (US)

(21) Appl. No.: 10/841,800

(22) Filed: May 6, 2004

Related U.S. Application Data
(60) Provisional application No. 60/469,357, filed on May 9, 2003.

(51) Int. Cl. A63F 13/00

(52) U.S. Cl. 463/4

(57) ABSTRACT

In an interactive, computer generated animation, a primary element is controlled by a user with a primary controller. A secondary element is controlled by the user with a secondary controller that generally includes a right analog stick. The secondary element is controlled by moving the stick. The secondary element may be controlled during occurrence of an event or prior to a scheduled event.

### CROSS-REFERENCES TO RELATED APPLICATIONS

This application claims priority of Application No. 60/469,357, filed May 9, 2003, entitled “Playmaker Control,” which disclosure is hereby incorporated herein by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to systems and methods for a secondary controller or secondary analog control stick, and more particularly, to systems and methods for controlling a secondary character with the control stick while controlling a primary character with a primary controller or control stick.

2. Description of the Prior Art

Many animation sequences, such as, for example, games, educational activities, interactive storytelling, interactive movie watching, etc., involve the use of some type of input device. These input devices may include keyboards, computer mice, track balls, and joysticks. With these input devices, animation characters or sequences may be controlled in a variety of ways.

Many of the games today involve team sports such as, for example, football, basketball, soccer, baseball, hockey, etc., as well as adventure-type games, flight simulation games, martial arts games, fighting and combat games, etc. Generally, players are only able to control one primary team member or character with a primary game controller. Control of the other team members is handled by a computer-type device with various programming, algorithms, etc. Thus, for example, a player controlling a quarterback in a football game may see that a receiver would be open if a certain modification were made to his route. Unfortunately, the player is unable to control the receiver with current game arrangements.

### BRIEF SUMMARY OF THE INVENTION

Broadly, with the present invention, in an interactive, computer generated animation sequence, a primary element is controlled by a user with a primary controller, which in one embodiment is a primary control device in the form of an analog stick or directional pad located on the left portion of a control or input mechanism. A secondary element is controlled by the user with a secondary controller, which in one embodiment is a secondary control device in the form of an analog controller that includes a stick located on the right portion of the control or input mechanism. The secondary element is controlled by moving the stick. The secondary element may be controlled during occurrence of an event or prior to a scheduled event.

In a more specific embodiment of the present invention, at least one secondary player on a multi-player team in a computer generated game that comprises a series of plays is controlled with an analog game controller that includes a stick. The secondary player is controlled by moving the stick. A primary player on the team is controlled with a primary game controller.

In accordance with one aspect of the present invention, the computer generated game is a football game.

In accordance with another aspect of the present invention, a single user plays the computer generated game.

In accordance with a further aspect of the present invention, two or more users play the computer generated game.

In accordance with yet another aspect of the present invention, the secondary character is controlled during a play.

In accordance with a further aspect of the present invention, the secondary character is controlled prior to a play.

In accordance with another aspect of the present invention, the computer generated game is a football game and the comprises one of a running back, a lead blocker and a receiver.

In accordance with a further aspect of the present invention, the computer generated game is a football game and the at least one secondary character comprises one of a defensive back, a linebacker and a group of defensive players.

In accordance with yet another aspect of the present invention, the secondary character is one of a running back and a receiver, and the secondary input mechanism controls a pass route.

In accordance with a further aspect of the present invention, the secondary character is one of a running back and a lead blocker, and the secondary input mechanism controls a blocking assignment.

Thus, the present invention is especially useful for games that involve teams of multiple players such as, for example, football, basketball, soccer, baseball, hockey, etc. or other types of games or interactive animation that include multiple characters, such as, for example, adventure simulations, flight simulation, martial arts games, fighting and combat games or simulations, etc., because it allows for a user to control more than one element, character or player. The present invention provides a new way of interacting with, overriding or influencing the artificial intelligence (AI) of a game and other players on the field for team sports. Thus, a user may make use of an analog control stick to make quick, on-the-fly decisions that affect the outcome of the secondary players, generally controlled by the central processor unit (CPU), for the purpose of bettering their performance in the game.

Other features and advantages of the present invention will be apparent in view of the following detailed description of preferred exemplary embodiments.

### BRIEF DESCRIPTION OF THE DRAWINGS

FIG. 1 is an illustration of an example of a game controller including an analog stick controller;

FIGS. 2 and 3 illustrate one example of secondary control with the analog stick controller in accordance with the present invention;

FIGS. 4-6 illustrate another example of secondary control with the analog stick controller in accordance with the present invention;

FIG. 7 illustrates another example of secondary control with the analog stick controller in accordance with the present invention; and

FIGS. 8 and 9 illustrate another example of secondary control with the analog stick controller in accordance with the present invention.

### DESCRIPTION SPECIFIC EXEMPLARY EMBODIMENTS OF THE INVENTION

The present invention provides systems and methods for controlling secondary elements, generally players or characters, in an interactive, multi-element animation, generally multi-player or multi-character games or team sports, generated and operated on a central platform or console such as, for example, a personal computer, a central game console, a portable game platform, a portable computer, a laptop computer, a notebook computer, a personal digital assistant, on-line through a network, or any next generation platform for playing games or interactive animation. While those skilled in the art will understand that the present invention may be useful for a variety of interactive computer operated games and animations, for clarity the present invention will be described with reference to an interactive computer operated football game.

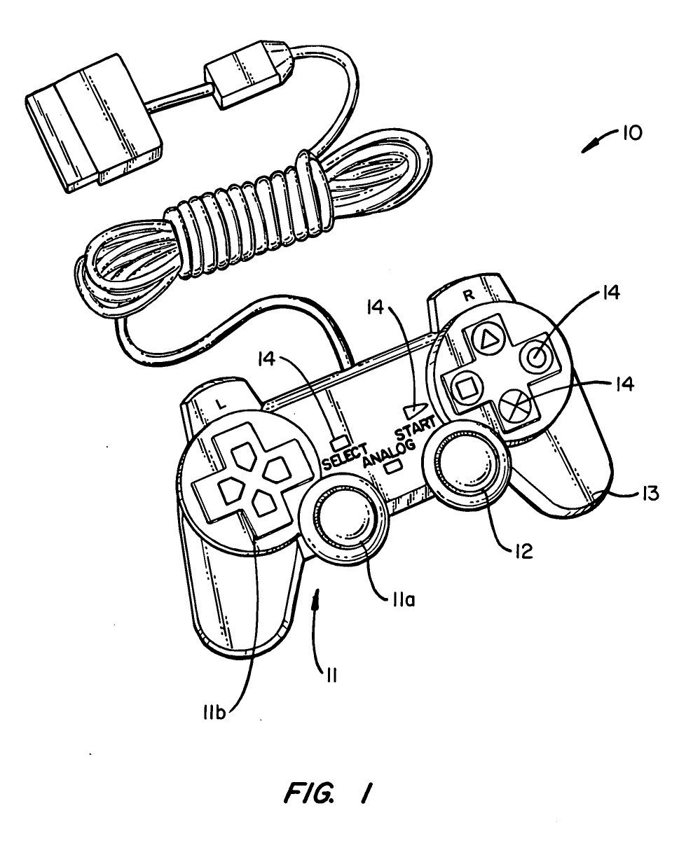

As may be seen in FIG. 1, a game controller 10 for use with the present invention preferably includes a primary controller 11 that is illustrated as a pivotable stick 11a and a directional pad 11b. The game controller further includes a secondary pivotable stick or knob controller 12. Both controller 11 and controller 12 are preferably analog. The game controller preferably includes a base 13. Input buttons 14 may be provided at various positions on the controller, for example, at various positions on the base or at various positions on the stick controller, such as at the top. Those skilled in the art will understand that other types of input mechanisms or controllers may be used with the present invention.

With the present invention, preferably control of a secondary element (player) may be provided prior to the occurrence of an event (play) or during the occurrence of the event (play). For example, control of a primary player prior to a football play being executed will generally be control of the quarterback (generally, once the play begins, the primary player changes based upon who has the ball). Thus, it may be useful to allow control of a secondary player such as a receiver. It may be desirable to alter the receiver's pass route upon seeing the defensive alignment. Likewise, once the play begins, it may be desirable to alter the receiver's pass route as the play unfolds or evolves. Generally, in the prior art this is not possible and the central controller or computer controls all of the players with its AI except for a primary player that is controlled by the user. Such secondary control may also be desirable with running backs and lineman for passing routes, blocking assignments, etc.

Additionally, when the user is controlling the defense, it may be desirable to control one or more players secondarily. For example, primary control may be for a linebacker or group of linebackers but it may be desirable to shift or move one or more players to a side or up closer to the line of scrimmage.

Offense

The following provides examples of secondary control in addition to or in place of CPU control of the secondary players for a user when they are operating or controlling an offense in an interactive computer controlled football game.

For a running play prior to the play being executed, it may be desirable to “flip the play without flipping the players.” When the user hits a direction on analog stick controller 12, the running play will totally flip (i.e., go the right instead of the left) but no players will change position, thus preventing the defense from being tipped-off. Preferably, the user is required to move controller 12 towards the opposite side of the play for this to trigger, i.e. take effect. Thus, if the user is initially running a dive off the right tackle, the user has to hit left on the analog controller, and the entire play will flip to a dive off the left tackle. This will control lead blockers, pulling guards, etc. Preferably, no players will move, except for animation that the quarterback (QB) will preferably provide when checking off the play. Preferably, the game just calls randomly one of two check-down animations, so that in a multi-user situation (i.e., one user controlling each team) the user on offense will not give away their play call.

In single-user and online situations (i.e., two users are playing each other online over the internet), the running back will preferably flash and a route arrow preferably appears, showing the new route for the running back. Obviously, in multi-user situations, this is not desirable and thus, in a preferred embodiment, an icon appears on the screen simply indicating that a change has occurred. For example, when a user has flipped their play, the only thing that is visible is the icon, and the QB performing his small animation. Examples for QB checkdown animations for flipping the play include: while at the line under center, the QB takes right hand and pats his leg twice while turning his head slightly to the left; or, while at the line and in a Shotgun formation, the QB takes his right hand and pats his leg twice while turning his head slightly to the left.

For a passing play prior to the play being executed, the user may choose to change his pass play. This is more of a check off than a “hot route.” In this example, a “VIP” or primary receiver (determined based upon the passing play selected) on the play will have his route changed to whatever route is relative to a corresponding analog controller movement. Preferably, if the VIP receiver is a halfback (HB) or fullback (FB), then a wide receiver (WR) will get the new route. When the control stick is moved, then preferably an icon will appear as previously described, and again, no players will move, except possibly for some type of animation as mentioned above with the QB checking off the play.

Examples of corresponding control stick movements for changing pass routes prior to executing a play include:

| Direction | Route Change |
|---|---|
| Up | Runs a wheel route. |
| Down | Runs 5 yard smash route. |
| Right | Runs flat route to the right. |
| Left | Runs flat route to the left. |

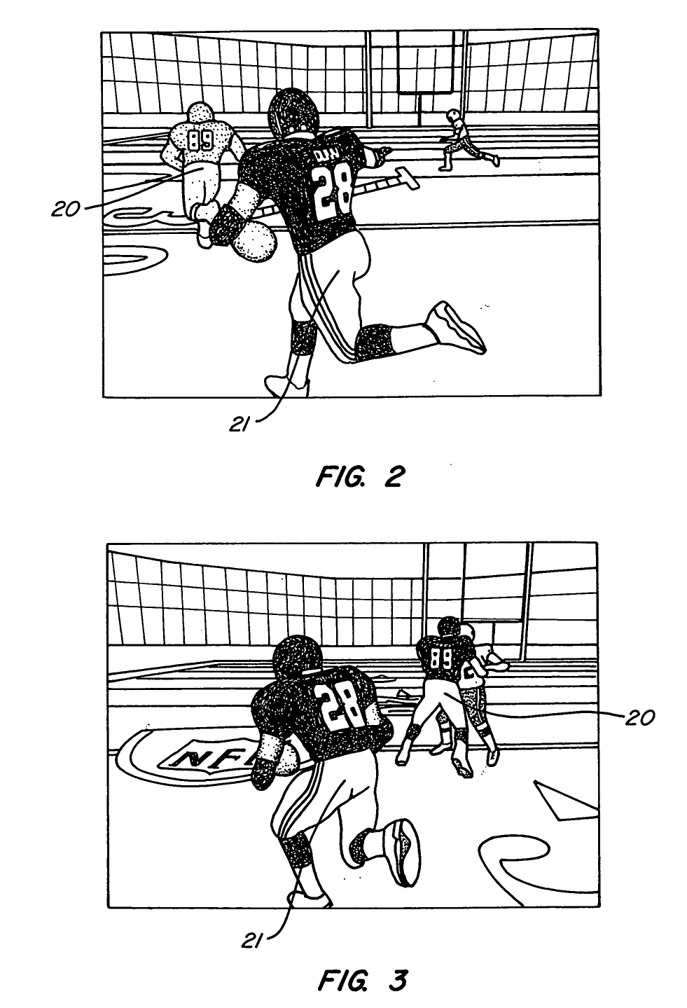

For a running play during execution of the play, it may be desirable to control one or more blockers. While running the ball, analog controller 12 may be used to guide blockers for the ball carrier, which is generally the primary player and is controlled by primary controller 11 once the play has begun. When running the ball, the user preferably is able to move the analog stick controller to point a blocking player in a particular direction. Thus, a blocking player (preferably that is not currently engaged by a defensive player) should head in the selected direction with a Lead Block assignment. See for example FIGS. 2 and 3, which illustrate player 20 being moved to block for player 21.

During execution of a passing play, when the QB has the ball, the analog stick controller preferably moves the receiver closest to the QB. Using the stick should ‘guide’ the receiver in the direction the user is pressing. The user preferably is only able to guide his receiver once that receiver has had a “Receiver Get Open” assignment from controller 10 (or AI). This way, the receiver may run the route that was selected prior to execution of the play and will only “break off” the route to try to get open when necessary. Thus, the receivers will execute the play they are supposed to. It is then up to the user to try and make something happen after the receiver has completed his route if, for example, the receiver did not get open or the QB has had to start scrambling to avoid being sacked. If the closest receiver to the QB is still not in “get open” mode, then the next closest receiver may be guided if desired.

Moving the receiver is preferably done in a manner of pointing in a direction with the analog stick controller. Preferably, the receiver moving towards the selected direction will still be in “get open” mode. The receiver preferably tries to adjust his movement to follow the direction selected. Preferably, the receiver will not be controlled directly by the user, and thus, he will simply head in the direction chosen.

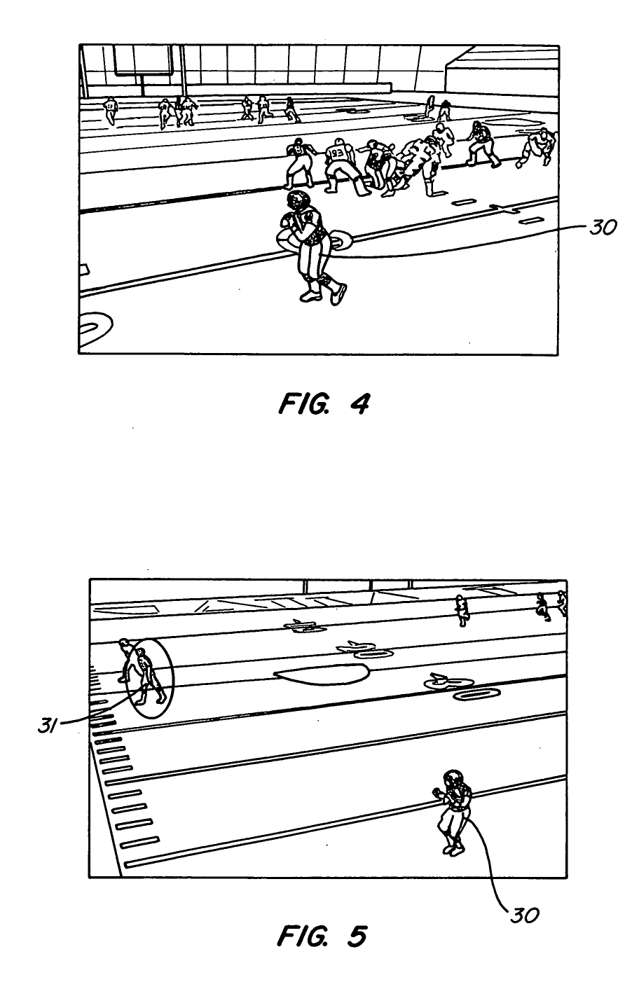

For example, with reference to FIGS. 4-6, Quarterback 30 rolls out of the pocket. No receivers are open, so the user presses up and right on the analog stick controller to make his nearest receiver 31 run away from his coverage and towards the endzone. The receiver thus takes off on a “streak” route.

Defense

The following provides examples of secondary control in addition to or in place of CPU control of secondary players for a user when they are operating or controlling a defense in an interactive computer controlled football game.

When a user's team is on defense, they may wish to control secondary players in addition to a primary player and shift their defensive formation prior to execution of the play. For example, a defensive adjustment may be made by pressing left or right on analog stick controller 12 to move a secondary player or players to the left or right. This could be used to control any players that are in a deep zone. Thus, this shifts players into a zone that is next to the one they are currently in. For example, a user may shift his safeties over to a certain side of the field if that side of the field is stacked. Examples of which zone a player may shift to, assuming the football playing field is divided into thirds is as follows (These assignments are listed as if one is viewing the defense from behind.):

| Original | Left | Right |
|---|---|---|
| Left Half | Mid 3^{rd} | Left 3^{rd} |
| Right Half | Right 3^{rd} | Mid 3^{rd} |
| Left 3^{rd} | Left Quarter In | Left Quarter Out |
| Right 3^{rd} | Right Quarter Out | Right Quarter In |
| Mid 3^{rd} | Right Half | Left Half |
| Right Quarter Out | SAME | Right 3^{rd} |
| Right Quarter In | Right Quarter Out | Left Quarter In |
| Left Quarter Out | Left 3^{rd} | SAME |
| Left Quarter In | Right Quarter In | Left Quarter Out |

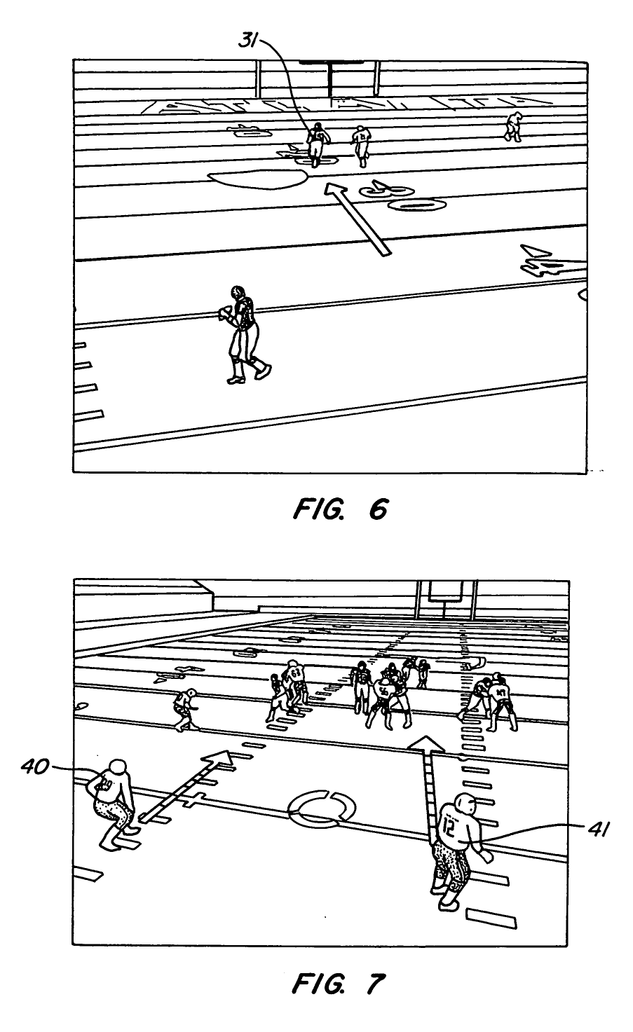

Additionally, the user may wish to have a secondary player or players “react” at the snap of the ball. For example, a defensive adjustment may be made by pressing any part of “DOWN” on the analog stick controller. Preferably, this is a read that the user has to make within 1 second of the snap of the ball. Pressing down on the analog stick controller may, for example, cause defender(s) to perform the following:
Safeties: “Freezes” them towards the run. If in man coverage, no action. See for example FIG. 7, which illustrates safeties 40, 41 “freezing” and then coming up to defend against the run as indicated by the arrows.
Corners: Take steps towards blitzing—cheat towards run. If in man coverage, no action.
Linebackers: Read run (blitz)
Defensive Line: No Action

Preferably, the user may also “cheat” to a side of the field. Thus, if the user thinks it is a run to the left, the user should move the analog controller DOWN-LEFT, and thereby “cheat” or move players to the left. Accordingly, the user may cheat players up for the run, thus leaving the players susceptible to the play action pass.

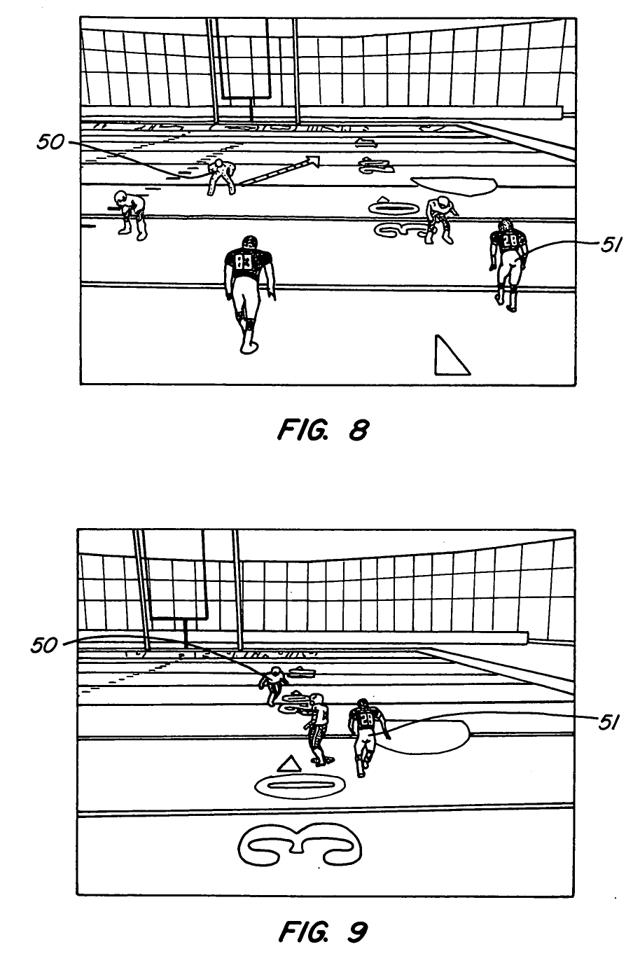

Another example of a possible adjustment of secondary players during a play on defense, is to move the analog controller UP at any time to send a safety into a deeper zone (assuming the defense is in a zone defense arrangement). Whatever zone the safety is currently in, they stay in that zone but move the zone back 5 yards. This would be for “over the top” help from a safety if the user recognizes a deep pass. See for example FIGS. 8 and 9, which illustrate safety 50 coming to help cover receiver 51.

As noted above, graphics, and even sound, may be used to provide some indication of the secondary player adjustments made, depending upon the user situation (single user or multi-user). For example, based upon the examples provided above:
Pre-Play Offense
   Highlight the player that has had their assignment changed, and show their route (in single player and only on the user's screen in an online multi-user situation). If in a multi-user situation, do not show this.
During Play Offense Passing
   Highlight the receiver that has moved due to user input. Use a color or flash, showing the receiver direction change. Same as above, only in single player and online.
   The QB will point in towards the direction the user moved the analog stick controller.
During Play Offense Running
   Highlight (flash) the new lead blocker.
   The RB should point towards the direction the user moved the analog stick controller.
Pre-Play Defense
   Trigger defensive shifting animations for any safety involved.
During Play Defense
   Move the controller when you move the analog controller DOWN. May trigger an audio line of “BLITZ!” or “RUN!”. When the user moves the analog controller UP, highlight any player that has his zone moving with an arrow or highlight.

Thus, the present invention provides methods for controlling secondary elements, characters or players with a secondary controller, preferably in the form of a pivotable stick or knob controller while a primary controller, preferably in the form of a control stick or directional pad, controls primary elements, characters or players. The present invention is especially useful for games and interactive animation that involve multiple characters and teams of multiple players such as, for example, football, basketball, soccer, baseball, hockey, etc., as well as adventure games or simulation, flight games or simulation, martial arts games or simulation, fighting and combat games or simulation, etc., because it allows for a user to control more than one element or player. The present invention provides a new way of interacting with, influencing or even overriding the artificial intelligence (AI) of a game and other players on the field for team sports and other computer controlled games and animations. Thus, a user may make use of an analog control stick to make quick, on-the-fly decisions that affect the outcome of the secondary players generally controlled by the central processor unit (CPU), for the purpose of bettering their performance in the game. Those skilled in the art will understand that there are other types of secondary control that may be provided for an interactive computer controlled football game and that there will be other types of control depending upon the game played or animation sequence.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of controlling at least one secondary character in a multi-character, computer generated game, the method comprising:
providing a central computer for generating and operating the computer generated game;
providing a primary input mechanism in communication with the central computer;
providing a secondary input mechanism including a stick in communication with the central computer;
controlling at least one primary character with the primary input mechanism; and
controlling the at least one secondary character with the secondary input mechanism by moving the stick.

2. A method in accordance with claim 1 wherein the computer generated game is a football game.

3. A method in accordance with claim 1 wherein a single user plays the computer generated game.

4. A method in accordance with claim 1 wherein two or more users play the computer generated game.

5. A method in accordance with claim 1 wherein the at least one secondary character is controlled during a play.

6. A method in accordance with claim 1 wherein the at least one secondary character is controlled prior to a play.

7. A method in accordance with claim 5 wherein the computer generated game is a football game and the at least one secondary character comprises one of a running back, a lead blocker and a receiver.

8. A method in accordance with claim 6 wherein the computer generated game is a football game and the at least one secondary character comprises one of a running back, a lead blocker and a receiver.

9. A method in accordance with claim 5 wherein the computer generated game is a football game and the at least one secondary character comprises one of a defensive back, a linebacker and a group of defensive players.

10. A method in accordance with claim 6 wherein the computer generated game is a football game and the at least one secondary character comprises one of a defensive back, a linebacker and a group of defensive players.

11. A method in accordance with claim 7 wherein the at least one secondary character is one of a running back and a receiver and the secondary input mechanism controls a pass route.

12. A method in accordance with claim 7 wherein the at least one secondary character is one of a running back and a lead blocker and the secondary input mechanism controls a blocking assignment.

13. A method in accordance with claim 8 wherein the at least one secondary character is one of a running back and a receiver and the secondary input mechanism controls a pass route.

14. A method in accordance with claim 8 wherein the at least one secondary character is one of a running back and a lead blocker and the secondary input mechanism controls a running route.

15. A method of controlling at least one secondary player on a multi-player team in a computer generated football game that comprises a series of plays, the method comprising:
providing a central computer for generating and operating the computer generated game;
providing a primary game controller in communication with the central computer;
providing an analog game controller including a stick in communication with the central computer;
controlling at least one primary player with the primary game controller; and
controlling the at least one secondary player with the analog game controller by moving the stick;
wherein the at least one secondary player comprises one of a receiver, a running back, a lead blocker, a defensive back, a linebacker or a group of defensive players; and
wherein the analog game controller controls one of a pass pattern route, a running route, and defensive position.

16. A method in accordance with claim 15 wherein a single user plays the computer generated game.

17. A method in accordance with claim 15 wherein two or more users play the computer generated game.

18. A method in accordance with claim 15 wherein the at least one secondary player is controlled during a play.

19. A method in accordance with claim 15 wherein the at least one secondary player is controlled prior to a play.

20. A method of controlling at least one secondary element in a multi-element, computer generated animation sequence that comprises a series of events, the method comprising:
providing a central computer for generating and operating the computer generated animation sequence;
providing a primary game controller in communication with the central computer;
providing a secondary controller including a stick in communication with the central computer;
controlling at least one primary element with the primary game controller; and
controlling the at least one secondary element with the secondary controller by moving the stick.

21. A method in accordance with claim 20 wherein a single user participates in the animation sequence.

22. A method in accordance with claim 20 wherein two or more users participate in the animation sequence.

23. A method in accordance with claim 1 wherein the at least one secondary element is controlled during an event.

24. A method in accordance with claim 20 wherein the at least one secondary player is controlled prior to an event.
